(19) United States
(12) Patent Application Publication
(10) Pub. No.: US 2016/0168401 A1
(43) Pub. Date: Jun. 16, 2016

(54) AQUEOUS INKJET INKS CONTAINING POLYMERIC BINDERS WITH COMPONENTS TO INTERACT WITH CELLULOSE

(71) Applicant: E. I. DU PONT DE NEMOURS AND COMPANY, Wilmington, DE (US)

(72) Inventors: C. Chad Roberts, Hockessin, DE (US); Christian Jackson, Wilmington, DE (US)

(21) Appl. No.: 14/907,341

(22) PCT Filed: Aug. 4, 2014
(86) PCT No.: PCT/US2014/049555

§ 371 Date: Jan. 25, 2016

Related U.S. Application Data
(60) Provisional application No. 61/862,558, filed on Aug. 6, 2013.

(51) Int. Cl. C09D 11/107; C09D 11/30

(52) U.S. Cl. CPC C09D 11/107; C09D 11/30

(57) ABSTRACT

Disclosed are aqueous inkjet inks containing a polymeric ink additive as a binder. The binder contains a component capable of interacting with cellulose. Certain acrylate monomers having similar Hansen solubility parameters as cellulose were incorporated into the polymeric binders. Prints from these inks have better durability than similar additives that do not have the components capable of interacting with cellulose.

This application claims priority under 35 U.S.C. §119 from U.S. Provisional Application Ser. No. 61/862,558, filed Aug. 6, 2013.

### BACKGROUND OF THE DISCLOSURE

The present disclosure pertains to an inkjet ink, in particular to an aqueous inkjet ink comprising colorants and polymeric ink additives which are derived from acrylic/acrylate polymers which have at least one component that can interact with cellulose.

Polymeric ink additives are common for inkjet ink. They are often included to improve the durability of the printed ink, and for adjustment of viscosity and other important ink properties, etc.

U.S. patent application publication Nos. 20080264298 and 20070100023 disclose dispersants capable of interacting with calcium components present in many types of paper.

While inks based on aqueous dispersions with polymeric additives have provided improved inkjet inks for many aspects of inkjet printing, a need still exists for improved inkjet ink formulations that provide good print quality and good jettability in particular when used in a thermal inkjet printhead. It is well known to those of ordinary skill in the art that thermal inkjet printheads have lower tolerance towards the addition of polymer additives on its jettability and reliability compared to piezo inkjet printheads. The present disclosure satisfies this need by providing compositions having improved print durability, while maintaining other aspects of the ink properties such as dispersion stability, long nozzle life and the like.

### SUMMARY OF THE DISCLOSURE

An embodiment provides an aqueous inkjet ink comprising a colorant, an aqueous vehicle, and a polymeric ink additive as a binder, wherein said polymeric ink additive is a random or structured polymer and comprising at least three monomers A, B and C; wherein monomer A is a hydrophobic acrylate monomer, monomer B is a hydrophilic acrylic monomer, and monomer C is an acrylate monomer having a structure of Formula (I):

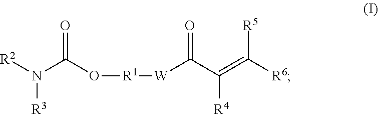

wherein W is O or NH;
R¹ is C₁-C₈ alkyl;
R², R³, R⁴, R⁵ and R⁶ are independently H or C₁-C₅ alkyl.

Another embodiment provides that monomer A is selected from the group consisting of benzyl methacrylate, butyl methacrylate, methyl methacrylate, ethyl methacrylate, propyl methacrylate, hexyl methacrylate, 2-ethylhexyl methacrylate, octyl methacrylate, lauryl ethacrylate, stearyl methacrylate, phenyl methacrylate, phenoxyethyl methacrylate, methyl acrylate, ethyl acrylate, propyl acrylate, butyl acrylate, hexyl acrylate, 2-ethylhexyl acrylate, octyl acrylate, lauryl acrylate, stearyl acrylate, benzyl acrylate, phenyl acrylate, phenoxyethyl acrylate, and styrene.

Another embodiment provides that monomer B is selected from the group consisting of methacrylic acid, acrylic acid, maleic acid, maleic acid monoester, itaconic acid, itaconic acid monoester, crotonic acid, crotonic acid monoester, N,N-dimethylaminoethyl methacrylate, N,N-diethylaminoethyl methacrylate, N,N-dimethylaminoethyl acrylate, N,N-diethylaminoethyl acrylate, t-butylaminoethyl methacrylate, t-butylaminoethyl acrylate, vinyl pyrridine, N-vinyl pyrridine, and 2-acrylamido-2-propane sulfonic acid.

Another embodiment provides that W is O.

Another embodiment provides that R¹ is CH₂CH₂(CH₃).

Another embodiment provides that R² and R³ are H.

Another embodiment provides that R² and R³ are C₁-C₅ alkyl.

Another embodiment provides that R¹ is C₂H₄.

Another embodiment provides that R¹ is CH₂.

Yet another embodiment provides that W is NH.

These and other features and advantages of the present embodiments will be more readily understood by those of ordinary skill in the art from a reading of the following Detailed Description. Certain features of the disclosed embodiments which are, for clarity, described above and below as separate embodiments, may also be provided in combination in a single embodiment. Conversely, various features of the disclosed embodiments that are described in the context of a single embodiment, may also be provided separately or in any subcombination.

### DETAILED DESCRIPTION

Unless otherwise stated or defined, all technical and scientific terms used herein have commonly understood meanings by one of ordinary skill in the art to which this disclosure pertains.

Unless stated otherwise, all percentages, parts, ratios, etc., are by weight.

When an amount, concentration, or other value or parameter is given as either a range, preferred range or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range.

Unless it is otherwise stated or clear from the context, when discussing properties or components of an inkjet ink, the term “inkjet ink” may be understood to include inkjet ink sets.

When the term “about” is used in describing a value or an end-point of a range, the disclosure should be understood to include the specific value or end-point referred to.

As used herein, “comprising” is to be interpreted as specifying the presence of the stated features, integers, steps, or components as referred to, but does not preclude the presence or addition of one or more features, integers, steps, or components, or groups thereof. Additionally, the term “comprising” is intended to include examples encompassed by the terms “consisting essentially of” and “consisting of” Similarly, the term “consisting essentially of” is intended to include examples encompassed by the term “consisting of.”

As used herein, the term “dispersion” means a two phase system where one phase consists of finely divided particles (often in the colloidal size range) distributed throughout a bulk substance, the particles being the dispersed or internal phase and the bulk substance the continuous or external phase. The bulk system is often an aqueous system.

As used herein, the term “dispersion of pigment particles” is a stable dispersion of polymeric dispersed pigments which are normally used in inks and paints.

As used herein, the term “aqueous pigment dispersion” is an aqueous dispersion of pigments using polymeric dispersants.

As used herein, the term “paper” means a semisynthetic product made by chemical processing of cellulosic fibers. The term paper also refers to the variety of paper used in printing such as copy paper, photo paper, newsprint, brochure paper and the like.

As used herein, the term “solubility parameter” provides a numerical estimate of the degree of interaction between materials, and can be a good indication of solubility, particularly for non polar materials such as many polymers.

As used herein, the term “dispersant” means a surface active agent added to a suspending medium to promote uniform and maximum separation of extremely fine solid particles often of colloidal size. For pigments, the dispersants are most often polymeric dispersants and usually the dispersants and pigments are combined using dispersing equipment.

As used herein, the term “structured polymer” means a polymer that is composed of segments that differ in composition from each other. Examples include diblock, triblock, graft and star polymers.

As used herein, the term “random polymer” means a polymer that is composed of monomers distributed in a random fashion in the polymer in much the same mole ratio of the monomers in the initial monomer composition.

As used herein, the term “ionically stabilized dispersions”, (“ISD”) are polymerically stabilized dispersions where the stabilization is due to ionic stabilization with little or no steric stabilization.

As used herein, the term “dispersible particles” are those particles that can be dispersed with dispersants including polymeric dispersants.

As used herein, the term “stable dispersion” means a dispersion of particles where the particle size growth is less than 10% particle size growth and no flocculation when the dispersion is stored at room temperature for at least a week.

As used herein, the term “pigment” means any substance usually in a powder form which imparts color to another substance or mixture. Disperse dyes, white and black pigments are included in this definition.

As used herein, the term “P/D” means the pigment to dispersant weight ratio in the initial dispersion formulation.

As used herein, the term “ambient conditions” refers to surrounding conditions, which are often around one atmosphere of pressure, about 50% relative humidity, and about 25° C.

As used herein, the term “crosslinking” means the chemical reaction between reactive groups on at least two different chemicals, where one of the chemicals is at least disubstituted.

As used herein, the term “emulsion” means a stable mixture of two or more immiscible liquids held in suspension by small percentages of substances called emulsifiers.

As used herein, the term “miniemulsion” means dispersions of relatively stable oil droplets with a size in the 50 to 500 nanometer region prepared by shearing a system containing an oil, water, and a surfactant.

As used herein, the term “nonionic” means an oligomer or polymer derived from ethylene oxide and/or propylene oxide where there are at least 4 of the ethylene oxide or propylene oxide groups.

As used herein, the term “heterocycle” means a cyclic ring compound which consists of carbon atoms and at least one N, O, or S in the ring and contains 4-7 total atoms in ring. The carbon atom(s) on the ring may optionally form carbonyl group(s).

As used herein, the term “ink additive” means a component added when the various inkjet ink components are combined to make an ink.

As used herein, the term “binder” means a film forming ingredient in the inkjet ink. This binder is normally added when the ink is formulated and is considered a polymeric ink additive.

As used herein, the term “HSD” means High Speed Dispersing.

As used herein, the term “OD” means optical density.

As used herein, the term “color saturation” is defined as chroma normalized by lightness L*, in the CIELAB color space; this is:

$${s}_{ab} = \frac{{C}_{ab}^{*}}{{L}^{*}} .$$

As used herein, the term “Gloss” means observation of reflected light from a printed surface, normally the printed substrate is glossy paper.

As used herein, the term “SDP” means “self-dispersible”, “self-dispersing” or “self-dispersed” pigment.

As used herein, the term “aqueous vehicle” refers to water or a mixture of water and at least one water-soluble organic solvent (co-solvent).

As used herein, the term “ionizable groups”, means potentially ionic groups.

As used herein, the term “substantially” means being of considerable degree, almost all.

As used herein, the term “Mn” means number average molecular weight usually reported in daltons.

As used herein, the term “Mw” means weight average molecular weight usually reported in daltons.

As used herein, the term “Pd” means the polydispersity which is the weight average molecular weight divided by the number average molecular weight.

As used herein, the term “D50” means the particle size at which 50% of the particles are smaller; “D95” means the particle size at which 95% of the particles are smaller.

As used herein, the term “cP” means centipoise, a viscosity unit.

As used herein, the term “conductivity” means the property of a substance or mixture that describes its ability to transfer electricity and is reported as mS/cm.

As used herein, the term “pre-polymer” means the polymer that is an intermediate in a polymerization process, and can also be considered a polymer.

As used herein, the term “AN” means acid number, mg KOH/gram of solid polymer.

As used herein, the term “neutralizing agents” means to embrace all types of agents that are useful for converting ionizable groups to the more hydrophilic ionic (salt) groups.

As used herein, the term “PUD” means the polyurethane dispersions described herein.

As used herein, the term “GPC” means gel permeation chromatography.

As used herein, the term “THF” means tetrahydrofuran.

As used, herein, the term “IMEMA” refers to imidazolylethyl methacrylate, a monomer from BASF.

As used herein, the term “DMPA” means dimethylol propionic acid.

As used herein, the term “TMXDI” means tetramethyl xylylene diisocyanate.

As used herein, Etemacoll® UH-50 is a polycarbonate diol from UBE Industries, Tokyo, Japan.

Denacol® 321 is trimethylolpropane polyglycidyl ether, a cross-linking reagent from Nagase Chemicals Ltd., Osaka, Japan.

As used herein, the term “DEA” means diethanolamine.

As used herein, the term “PROXEL™ biocide” refers to a biocide obtained from Arch Chemicals, Norwalk, Conn.

As used herein, the term “Surfynol® 465” refers to surfactant from Air Products (Allentown, Pa. USA).

As used herein, the term “Glycereth-26” refers to a 26 mole ethylene oxide adduct of glycerin.

As used herein, the term “2-P (95/5)” means 2-Pyrrolidone supplied as a 5% water mixture.

Unless otherwise noted, the above chemicals were obtained from Aldrich (Milwaukee, Wis.) or other similar suppliers of laboratory chemicals.

### Polymeric Binders

A model for effective use of pigments in inkjet inks is that a pigment is held onto the surface of a substrate resulting high optical density and other desirable print properties. Examples of “holding” the pigment onto the surface include using a fixing agent that reacts or effects the pigment when it is jetted onto the substrate, using self-dispersing pigments, and using dispersants that are designed to interact with calcium as suggested in US20080264298 and US200070100023, etc. Calcium carbonate is often a component of paper, especially for copy paper and similar papers used for inkjet printing.

While seeking new ways to obtain better durability of printed images from inkjet inks, a set of monomers was identified as capable of interacting with cellulose which is the predominant component in paper. These monomers were selected by matching their Hansen solubility parameters with that of cellulose. Inclusion of these monomers in a polymerization process provides the polymeric binders of the present disclosure. While not being bound by theory, it is concluded that if a binder contains monomers that can interact with cellulose, the resulting inkjet inks will behave differently. Upon jetting on paper, the binder can bind to the paper to provide improved durability.

Accordingly, polymeric binders having functionalities capable of interacting with cellulose were prepared. The polymeric binders comprise at least three monomers A, B and C; where monomer A is a hydrophobic acrylate monomer, monomer B is a hydrophilic acrylic monomer, and monomer C is an acrylate monomer having a structure of Formula (I):

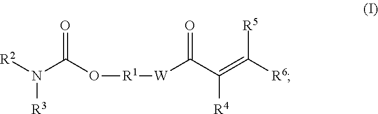

wherein W is O or NH;

R¹ is C₁-C₈ alkyl; and

R², R³, R⁴, R⁵ and R⁶ are independently H or C₁-C₅ alkyl.

The amounts of the monomers are between 10 to 80% of monomer A, between 5 to 50% of monomer B, and between 5 to 50% of monomer C.

The polymeric binder of the present disclosure has a number average molecular weight of 2000 to 30000 daltons.

The hydrophilic acrylic monomer provides ionic content for the polymeric binder. The amount of acid content may be measured as an acid number (AN, mg KOH per gram solid polymer). The lower limit for acid number is about 10, and the upper limit for the acid number is about 250.

The polymeric binder may be either a random or structured polymer. The polymer binder can be a copolymer of hydrophobic (monomer A), hydrophilic (monomer B) monomers and the heterocycle containing acrylate monomer C.

The structured polymeric binder may be water soluble and may have a solubility of at least 10 grams of polymer/100 grams of water at 25° C. The solubility is measured in its neutralized form.

### Colorants

Suitable colorants for the inks include soluble colorants such as dyes and insoluble colorants such as dispersed pigments (pigment plus dispersing agent) and self-dispersed pigments.

Conventional dyes such as anionic, cationic, amphoteric and non-ionic dyes are suitable. Such dyes are well known to those of ordinary skill in the art. Anionic dyes are those dyes that, in aqueous solution, yield colored anions. Cationic dyes are those dyes that, in aqueous solution, yield colored cations. Typically anionic dyes contain carboxylic or sulfonic acid groups as the ionic moiety. Cationic dyes usually contain quaternary nitrogen groups.

The types of anionic dyes most suitable are, for example, Acid, Direct, Food, Mordant and Reactive dyes. Anionic dyes are selected from the group consisting of nitroso compounds, nitro compounds, azo compounds, stilbene compounds, triarylmethane compounds, xanthene compounds, quinoline compounds, thiazole compounds, azine compounds, oxazine compounds, thiazine compounds, aminoketone compounds, anthraquinone compounds, indigoid compounds and phthalocyanine compounds.

The types of cationic dyes that are most suitable include mainly the basic dyes and some of the mordant dyes that are designed to bind acidic sites on a substrate, such as fibers. Useful types of such dyes include the azo compounds, diphenylmethane compounds, triarylmethanes, xanthene compounds, acridine compounds, quinoline compounds, methine or polymethine compounds, thiazole compounds, indamine or indophenyl compounds, azine compounds, oxazine compounds, and thiazine compounds, among others, all of which are well known to those skilled in the art.

Useful dyes include (cyan) Acid Blue 9 and Direct Blue 199; (magenta) Acid Red 52, Reactive Red 180, Acid Red 37, CI Reactive Red 23; and (yellow) Direct Yellow 86, Direct Yellow 132 and Acid Yellow 23.

Pigments suitable for use are those generally well-known in the art for aqueous inkjet inks. Traditionally, pigments are stabilized by dispersing agents, such as polymeric dispersants or surfactants, to produce a stable dispersion of the pigment in the vehicle. Representative commercial dry pigments are listed in U.S. Pat. No. 5,085,698. Dispersed dyes are also considered pigments as they are insoluble in the aqueous inks used herein.

A wide variety of organic and inorganic pigments, alone or in combination, may be selected to make the ink. The term “pigment” as used herein means an insoluble colorant which includes dispersed dyes as they are insoluble in the inkjet ink. The pigment particles are sufficiently small to permit free flow of the ink through the inkjet printing device, especially at the ejecting nozzles that usually have a diameter ranging from about 10 micron to about 50 micron. The particle size also has an influence on the pigment dispersion stability, which is critical throughout the life of the ink. Brownian motion of minute particles will help prevent the particles from flocculation. It is also desirable to use small particles for maximum color strength and gloss. The range of useful particle size is typically about 0.005 micron to about 15 micron, and in embodiments, the pigment particle size ranges from about 0.005 to about 5 micron, and in embodiments, from about 0.005 to about 1 micron. The average particle size as measured by dynamic light scattering is preferably less than about 500 nm, more preferably less than about 300 nm.

The selected pigment(s) may be used in dry or wet form. For example, pigments are usually manufactured in aqueous media and the resulting pigment is obtained as water-wet presscake. In presscake form, the pigment is not agglomerated to the extent that it is in dry form. Thus, pigments in water-wet presscake form do not require as much deflocculation in the process of preparing the inks as pigments in dry form.

The dispersed pigment may be purified after the dispersion process by filtration, ultrafiltration or other processes used for purification of dispersed pigments.

The polymerically dispersed pigments may have the polymeric dispersants crosslinked after the dispersion process is completed. In this case the pigment is thought to have its polymeric dispersants crosslinked to each other by the addition of crosslinked components. A type of this crosslinking is described in U.S. Pat. No. 6,262,152.

The pigment of the present disclosure can also be a self-dispersing (or self-dispersible) pigment. The term self-dispersing pigment (or “SDP”) refers to pigment particles whose surface has been chemically modified with hydrophilic, dispersability-imparting groups that allow the pigment to be stably dispersed in an aqueous vehicle without a separate dispersant. “Stably dispersed” means that the pigment is finely divided, uniformly distributed and resistant to particle growth and flocculation.

The SDPs may be prepared by grafting a functional group or a molecule containing a functional group onto the surface of the pigment, by physical treatment (such as vacuum plasma), or by chemical treatment (for example, oxidation with ozone, hypochlorous acid or the like). A single type or a plurality of types of hydrophilic functional groups may be bonded to one pigment particle. The hydrophilic groups are carboxylate or sulfonate groups which provide the SDP with a negative charge when dispersed in aqueous vehicle. The carboxylate or sulfonate groups are usually associated with monovalent and/or divalent cationic counter-ions. Methods of making SDPs are well known and can be found, for example, in U.S. Pat. No. 5,554,739 and U.S. Pat. No. 6,852,156.

The SDPs may be black, such as those based on carbon black, or may be colored pigments. Examples of pigments with coloristic properties useful in inkjet inks include: Pigment Blue 15:3 and Pigment Blue 15:4 (for cyan); Pigment Red 122 and Pigment Red 202 (for magenta); Pigment Yellow 14, Pigment Yellow 74, Pigment Yellow 95, Pigment Yellow 110, Pigment Yellow 114, Pigment Yellow 128 and Pigment Yellow 155 (for yellow); Pigment Orange 5, Pigment Orange 34, Pigment Orange 43, Pigment Orange 62, Pigment Red 17, Pigment Red 49:2, Pigment Red 112, Pigment Red 149, Pigment Red 177, Pigment Red 178, Pigment Red 188, Pigment Red 255 and Pigment Red 264 (for red); Pigment Green 1, Pigment Green 2, Pigment Green 7 and Pigment Green 36264 (for green); Pigment Blue 60, Pigment Violet 3, Pigment Violet 19, Pigment Violet 23, Pigment Violet 32, Pigment Violet 36 and Pigment Violet 38 (for blue); and carbon black. However, some of these pigments may not be suitable for preparation as SDP. Colorants are referred to herein by their “C.I.”.

The SDPs of the present disclosure may have a degree of functionalization wherein the density of anionic groups is less than about 3.5 μmoles per square meter of pigment surface (3.5 μmol/m²), and more specifically, less than about 3.0 μmol/m². Degrees of functionalization of less than about 1.8 μmol/m², and more specifically, less than about 1.5 μmol/m², are also suitable and may be preferred for certain specific types of SDPs.

The range of useful particle size after dispersion is typically from about 0.005 micrometers to about 15 micrometers. Typically, the pigment particle size should range from about 0.005 micrometers to about 5 micrometers; and, specifically, from about 0.005 micrometers to about 1 micrometers. The average particle size as measured by dynamic light scattering is less than about 500 nm, typically less than about 300 nm.

The amount of pigment present in the ink is typically in the range of from about 0.1% to about 25% by weight, and more typically in the range of from about 0.5% to about 10% by weight, based on the total weight of ink. If an inorganic pigment is selected, the ink will tend to contain higher percentages by weight of pigment than with comparable inks employing organic pigment, since inorganic pigments generally have higher densities than organic pigments.

### Polymeric Dispersant

The polymeric dispersant for the non-self-dispersing pigment(s) may be a random or a structured polymer. Typically, the polymer dispersant is a copolymer of hydrophobic and hydrophilic monomers. The “random polymer” means polymers where molecules of each monomer are randomly arranged in the polymer backbone. For a reference on suitable random polymeric dispersants, see: U.S. Pat. No. 4,597,794. The “structured polymer” means polymers having a block, branched, graft or star structure. Examples of structured polymers include AB or BAB block copolymers such as the ones disclosed in U.S. Pat. No. 5,085,698; ABC block copolymers such as the ones disclosed in EP Patent Specification No. 0556649; and graft polymers such as the ones disclosed in U.S. Pat. No. 5,231,131. Other polymeric dispersants that can be used are described, for example, in U.S. Pat. No. 6,117,921, U.S. Pat. No. 6,262,152, U.S. Pat. No. 6,306,994 and U.S. Pat. No. 6,433,117.

### Dispersion of the Pigment Particles

The dispersing step for the polymerically dispersed pigment may be accomplished in an ultrasonicator, media mill, a horizontal mini mill, an attritor, or by passing the mixture through a plurality of nozzles within a liquid jet interaction chamber at a liquid pressure of at least 5,000 psi to produce a uniform dispersion of the pigment particles in the aqueous carrier medium (microfluidizer). The media for the media mill is chosen from commonly available media, including zirconia, YTZ, and nylon. The media can be as small as about 0.1 microns, although particles larger than 0.3 microns are commonly used. These various dispersion processes are in a general sense well known in the art, as exemplified by U.S. Pat. No. 5,022,592, U.S. Pat. No. 5,026,427, U.S. Pat. No. 5,891,231, U.S. Pat. No. 5,679,138, U.S. Pat. No. 5,976,232 and US Patent Application Publication No. 20030089277. Preferred are media mill, and by-passing the mixture through a plurality of nozzles within a liquid jet interaction chamber at a liquid pressure of at least 5,000 psi. The mixing intensity required for the process is mixing normally associated with dispersion processes and not turbulent mixing of more modest mixing processes.

Combinations of dispersing equipment may be used. It may be more convenient to mix the solvent mixture, particle and polymeric dispersant in a High Speed Disperser (HSD) followed by milling in a media mill or a microfluidizer. The addition of the polar solvent may occur during the HSD portion of the processing and then the milling is continued in the media mill.

The final use of the particle dispersion may require that the solvent be removed from the particle dispersion mixture. The solvent may be removed by distillation processing, ultrafiltration or other convenient means. Any of these solvent removal methods may be incorporated into the process. The dispersing equipment and the solvent removal may be coupled and the solvent may be removed during the dispersing process and during the addition of the polar solvent.

One way to monitor the progress of the dispersion process is to measure the particle size and set a target value for the final D50 of the mixture. For typical pigments used for inkjet inks the target value of the D50 is 125 nm or less, preferably less than 100 nm. Also the D95 and the particles smaller than 204 nm can be used as a test criterion for the pigment dispersions.

A wide variety of organic and inorganic pigments, alone or in combination, may be selected for dispersion by this process. The dispersed pigment may be used in paints, inks and especially inkjet inks. The term “pigment” as used herein means an insoluble colorant and in the present application includes disperse dyes. The pigment particles are sufficiently small to permit free flow of the ink through the inkjet printing device, especially at the ejecting nozzles that usually have a diameter ranging from about 10 micron to about 50 micron. The particle size also has an influence on the pigment dispersion stability, which is critical throughout the life of the ink. Brownian motion of minute particles will help prevent the particles from flocculation. It is also desirable to use small particles for maximum color strength and gloss.

The dispersed pigment may be purified after the dispersion process by filtration, ultrafiltration or other processes used for purification of dispersed pigments.

### Crosslinked Polymeric Dispersant

The polymeric dispersant may be crosslinked after the pigment dispersion is prepared.

Polymeric dispersants substituted with crosslinkable moieties including acetoacetoxy, acid, amine, epoxy, hydroxyl, blocked isocyanates and mixtures thereof are capable of undergoing crosslinking. Typically, a crosslinking agent is added to effect crosslinking. Typical crosslinking agents include acetoacetoxy, acid, amine, anhydride, epoxy, hydroxyl, isocyanates, blocked isocyanates and mixtures thereof. The crosslinking of the polymeric dispersant is typically conducted after the pigment is dispersed. After the crosslinking step excess polymeric dispersant can be removed by purification processes such as ultrafiltration.

Specific examples of crosslinking moiety/agent pairs are hydroxyl/isocyanate and acid/epoxy.

The product of this crosslinking process is a stable, dispersed pigment. This stable pigment dispersion is one that has less than 10% particle size growth and no flocculation when the dispersion is stored at room temperature for at least a week. More rigorous testing that entails accelerated testing by heating samples for a week or more can also be used to determine the stability of the particle dispersions. The optimal particle dispersion stability would depend on the dispersion's characteristics and/or final use. Another criterion for a stable dispersed particle is that it can be processed under normal dispersing process conditions, without turning into a gel or having other adverse properties.

### Amounts/Ratios of the Ingredients

For the inkjet inks the amount of the polymeric ink additive can vary from 0.05 to 12% by weight based on the weight of the total ink composition. Alternatively the amount can be 0.2 to 7% by weight.

For inkjet inks the mass ratio of pigment to polymeric dispersant ranges from 0.33 to 400. This ratio is based on the mass of the pigment and that of the polymeric dispersant added to the dispersion. For organic pigments the ratio is 0.33 to 12, optionally 0.5 to 10. For inorganic pigments the ratio is 3 to 400, optionally 5 to 200.

In the case of organic pigments, the inkjet ink may contain up to approximately 30% of the pigment, optionally 0.11 to 25%, and further from 0.25 to 15% pigment by weight based on the total ink weight of the ink. If an inorganic pigment is selected, the ink will tend to contain higher weight percentages of pigment than with comparable inks employing organic pigment, and the ink may be as high as 75% in some cases, since inorganic pigments generally have higher specific gravities than organic pigments. Examples of inorganic pigments include titanium dioxide, iron oxides, and the like.

### Aqueous Carrier Medium

The aqueous carrier medium (aqueous vehicle) for the inkjet inks which utilize the encapsulated pigment described above is water or a mixture of water and at least one water-miscible organic solvent. Selection of a suitable mixture depends on requirements of the specific application, such as desired surface tension and viscosity, the selected pigment, drying time of the pigmented inkjet ink, and the type of paper onto which the ink will be printed. Representative examples of water-soluble organic solvents that may be selected include (1) alcohols, such as methyl alcohol, ethyl alcohol, n-propyl alcohol, iso-propyl alcohol, n-butyl alcohol, sec-butyl alcohol, t-butyl alcohol, iso-butyl alcohol, furfuryl alcohol, and tetrahydrofurfuryl alcohol; (2) ketones or ketoalcohols such as acetone, methyl ethyl ketone and diacetone alcohol; (3) ethers, such as tetrahydrofuran and dioxane; (4) esters, such as ethyl acetate, ethyl lactate, ethylene carbonate and propylene carbonate; (5) polyhydric alcohols, such as ethylene glycol, diethylene glycol, triethylene glycol, propylene glycol, tetraethylene glycol, polyethylene glycol, glycerol, 2-methyl-2,4-pentanediol 1,2,6-hexanetriol and thiodiglycol; (6) lower alkyl mono- or di-ethers derived from alkylene glycols, such as ethylene glycol mono-methyl (or -ethyl) ether, diethylene glycol mono-methyl (or -ethyl) ether, propylene glycol mono-methyl (or -ethyl) ether, triethylene glycol mono-methyl (or -ethyl) ether and diethylene glycol di-methyl (or -ethyl) ether; (7) nitrogen containing cyclic compounds, such as pyrrolidone, N-methyl-2-pyrrolidone, and 1,3-dimethyl-2-imidazolidinone; and (8) sulfur-containing compounds such as dimethyl sulfoxide and tetramethylene sulfone.

A mixture of water and a polyhydric alcohol, such as diethylene glycol, is preferred as the aqueous carrier medium. In the case of a mixture of water and diethylene glycol, the aqueous carrier medium usually contains from 30% water/70% diethylene glycol to 95% water/5% diethylene glycol. The preferred ratios are approximately 60% water/40% diethylene glycol to 95% water/5% diethylene glycol. Percentages are based on the total weight of the aqueous carrier medium. A mixture of water and butyl carbitol is also an effective aqueous carrier medium.

The amount of aqueous carrier medium in the ink is typically in the range of 70% to 99.8%, and preferably 80% to 99.8%, based on total weight of the ink.

The aqueous carrier medium can be made to be fast penetrating (rapid drying) by including surfactants or penetrating agents such as glycol ethers and 1,2-alkanediols. Glycol ethers include ethylene glycol monobutyl ether, diethylene glycol mono-n-propyl ether, ethylene glycol mono-iso-propyl ether, diethylene glycol mono-iso-propyl ether, ethylene glycol mono-n-butyl ether, ethylene glycol mono-t-butyl ether, diethylene glycol mono-n-butyl ether, triethylene glycol mono-n-butyl ether, diethylene glycol mono-t-butyl ether, 1-methyl-1-methoxybutanol, propylene glycol mono-t-butyl ether, propylene glycol mono-n-propyl ether, propylene glycol mono-iso-propyl ether, propylene glycol mono-n-butyl ether, dipropylene glycol mono-n-butyl ether, dipropylene glycol mono-n-propyl ether, and dipropylene glycol mono-isopropyl ether. 1,2-Alkanediols are preferably 1,2-C4-6 alkanediols, most preferably 1,2-hexanediol. Suitable surfactants include ethoxylated acetylene diols (e.g. Surfynols® series from Air Products), ethoxylated primary (e.g. Neodol® series from Shell) and secondary (e.g. Tergitol® series from Union Carbide) alcohols, sulfosuccinates (e.g. Aerosol® series from Cytec), organosilicones (e.g. Silwet® series from Witco) and fluoro surfactants (e.g. Zonyl® series from DuPont).

The amount of glycol ether(s) and 1,2-alkanediol(s) added must be properly determined, but is typically in the range of from 1 to 15% by weight and more typically 2 to 10% by weight, based on the total weight of the ink. Surfactants may be used, typically in the amount of 0.01 to 5% and preferably 0.2 to 4%, based on the total weight of the ink.

### Other Additives

Other ingredients, additives, may be formulated into the inkjet ink, to the extent that such other ingredients do not interfere with the stability and jettability of the inkjet ink. This may be readily determined by routine experimentation by one skilled in the art.

Surfactants are commonly added to inks to adjust surface tension and wetting properties. Suitable surfactants include the ones disclosed in the Vehicle section above.

Surfactants are typically used in amounts up to about 5% and more typically in amounts up to 2% by weight, based on the total weight of the ink.

Inclusion of sequestering (or chelating) agents such as ethylenediaminetetraacetic acid (EDTA), iminodiacetic acid (IDA), ethylenediamine-di(o-hydroxyphenylacetic acid) (EDDHA), nitrilotriacetic acid (NTA), dihydroxyethylglycine (DHEG), trans-1,2-cyclohexanediaminetetraacetic acid (CyDTA), diethylenetriamine-N,N,N′,N″,N″-pentaacetic acid (DTPA), and glycoletherdiamine-N,N,N′,N′-tetraacetic acid (GEDTA), and salts thereof, may be advantageous, for example, to eliminate deleterious effects of heavy metal impurities.

Polymers may be added to the ink to improve durability or other properties. The polymers can be soluble in the vehicle or in a dispersed form, and can be ionic or nonionic. Soluble polymers include linear homopolymers and copolymers or block polymers. They also can be structured polymers including graft or branched polymers, stars and dendrimers. The dispersed polymers may include, for example, latexes and hydrosols. The polymers may be made by any known process including, but not limited to, free radical, group transfer, ionic, condensation and other types of polymerization. They may be made by a solution, emulsion, or suspension polymerization process. Typical classes of polymer additives include anionic acrylic, styrene-acrylic and polyurethane polymer.

When a polymer is present, its level is typically between about 0.01% and about 3% by weight, based on the total weight of an ink. The upper limit is dictated by ink viscosity or other physical limitations.

### Ink Sets

The term “ink set” refers to all the individual inks or other fluids an inkjet printer is equipped to jet. Ink sets typically comprise at least three differently colored inks. For example, a cyan (C), magenta (M) and yellow (Y) ink forms a CMY ink set. More typically, an ink set includes at least four differently colored inks, for example, by adding a black (K) ink to the CMY ink set to form a CMYK ink set. The magenta, yellow and cyan inks of the ink set are typically aqueous inks, and may contain dyes, pigments or combinations thereof as the colorant. Such other inks are, in a general sense, well known to those of ordinary skill in the art.

In addition to the typical CMYK inks, an ink set may further comprise one or more “gamut-expanding” inks, including differently colored inks such as an orange ink, a green ink, a red ink and/or a blue ink, and combinations of full strength and light strength inks such as light cyan and light magenta. Such other inks are, in a general sense, known to one skilled in the art.

A typical ink set comprises a magenta, yellow, cyan and black ink, wherein the black ink is an ink according to the present disclosure comprising an aqueous vehicle and a self-dispersing carbon black pigment. Specifically, the colorant in each of the magenta, yellow and cyan inks is a dye.

### Ink Properties

Jet velocity, separation length of the droplets, drop size and stream stability are greatly affected by the surface tension and the viscosity of the ink. Pigmented ink jet inks typically have a surface tension in the range of about 20 dyne/cm to about 70 dyne/cm at 25° C. Viscosity can be as high as 30 cP at 25° C., but is typically somewhat lower. The ink has physical properties compatible with a wide range of ejecting conditions, i.e., driving frequency of the piezo element or ejection conditions for a thermal head for either a drop-on-demand device or a continuous device, and the shape and size of the nozzle. The inks should have excellent storage stability for long periods so as not to clog to a significant extent in an ink jet apparatus. Furthermore, the ink should not corrode parts of the ink jet printing device it comes in contact with, and it should be essentially odorless and non-toxic.

Although not restricted to any particular viscosity range or printhead, the inventive ink set is particularly suited to lower viscosity applications such as those required by thermal printheads. Thus the viscosity of the inventive inks at 25° C. can be less than about 7 cP, typically less than about 5 cP, and more typically than about 3.5 cP. Thermal inkjet actuators rely on instantaneous heating/bubble formation to eject ink drops and this mechanism of drop formation generally requires inks of lower viscosity.

### Substrate

The present embodiments are particularly advantageous for printing on plain paper, such as common electrophotographic copier paper and photo paper, glossy paper and similar papers used in inkjet printers.

### EXAMPLES

The following examples illustrate various embodiments of the present disclosure without, however, being limited thereto. Tests listed here are those that are commonly used for testing pigment dispersions and inkjet inks.

The particle size for the pigment dispersions and the inks were determined by dynamic light scattering using a MICROTRAC UPA 150 analyzer from Honeywell/Microtrac (Montgomeryville Pa.).

This technique is based on the relationship between the velocity distribution of the particles and the particle size. Laser generated light is scattered from each particle and is Doppler shifted by the particle Brownian motion. The frequency difference between the shifted light and the unshifted light is amplified, digitalized and analyzed to recover the particle size distribution. Results are reported as D50 and D95 and particles less than 204 nm.

### MW Characterization of the Polymeric Ink Additives

Gel Permeation Chromatography or GPC was used to verify predicted molecular weight and molecular weight distribution. The GPC system included a Waters 1515 Isocratic HPLC Pump, Waters 2414 Refractive Index Detector, 717 plus Waters Autosampler, Four Styregel Columns (HR 0.5, HR 1, HR 2, and HR 4) in series in a Waters Column Heater set to 40° C. Samples were eluted with Tetrahydrofuran (THF) at a flow rate of 1 mL/min. The samples were analyzed using Breeze 3.30 Software with a calibration curve developed from narrow molecular weight, polymethylmethacrylate (PMMA) standards. Based on light scattering data from Polymer Laboratories Ltd., the nominal, peak molecular weight for the PMMA standards were as follows: 300000, 150000, 60000, 30000, 13000, 6000, 2000, and 1000.

The inks were tested by printing on various substrates with Epson and HP printers. Plain paper, glossy paper and brochure paper were tested.

The optical density was measured using a Greytag-Macbeth SpectroEye™ instrument (Greytag-Macbeth AG, Regensdorf, Switzerland).

### Polyurethane Dispersant

To a dry alkali- and acid-free flask equipped with an additional funnel, a condenser and a stirrer, under a nitrogen atmosphere was added Terathane 650, DMPA, Sulfolane and DBTL. The resulting mixture was heated to 60° C. and thoroughly mixed. To this mixture was added IDPI via the additional funnel mounted on the flask followed by rinsing any residual IDPI in the additional funnel into the flask with Sulfolane. The temperature for the reaction mixture was raised to 85° C. and maintained at 85° C. until the isocyanate content reached 1.2% or below. The temperature was then cooled to 60° C. and maintained at 60° C. while DEA was added via the additional funnel over a period of 5 minutes followed by rinsing the residual DEA in the additional funnel into the flask with Sulfolane. After holding the temperature for 1 hr at 60° C., aqueous KOH was added over a period of 10 minutes via the additional funnel followed by de-ionized water. The mixture was maintained at 60° C. for 1 hr and cooled to room temperature to provide a polyurethane dispersant with an acid number of 80 mg/KOH and 20.16% of solids.

### Preparation of Pigmented Dispersions

Pigmented dispersions were prepared with a carbon black pigment. The following procedure was used to prepare pigmented dispersions with the polyurethane dispersant. A premix was prepared at typically 20-30% pigment loading and the targeted dispersant level was selected at a pigment/dispersant (P/D) ratio of about 3.0. Optionally, a co-solvent was added at 10% of the total dispersion formulation to facilitate pigment wetting and dissolution of dispersant in the premix stage and ease of grinding during milling stage. Although other similar co-solvents are suitable, triethylene glycol monobutyl ether (TEB as supplied from Dow Chemical) was the co-solvent of choice. The polyurethane dispersant prepared above can be pre-neutralized with either KOH to facilitate solubility and dissolution into water. During the premix stage, the pigment level was maintained at typically 27%, and was subsequently reduced to about 24% during the milling stage by the addition of de-ionized water for optimal media mill grinding conditions. After completion of the milling stage, which was typically 4 hours, the remaining letdown of de-ionized water was added and. thoroughly mixed.

All the pigmented dispersions processed with co-solvent were purified using an ultrafiltration process to remove co-solvent(s) and filter out other impurities that may be present. After completion, the pigment levels in the dispersions were reduced to about 10 to 15

### Preparation of Cross-Linked Black Pigment Dispersion 1

In the cross-linking step, a cross-linking compound, Denacaol 321, was mixed with the pigmented dispersion above and heated between 60° C. and 80° C. with efficient stirring for between 6 to 8 hours. After the cross-linking reaction was completed, the pH was adjusted to at least about 8.0 if needed.

### Preparation of Binder Ink Additives

### Ink Additive 1: 20HPCA/60BzMA/20MAA

A 2 L round bottom reactor equipped with mechanical stirrer, water cooled condenser and Nitrogen purge was loaded with 128.7 g 2-pyrrollidone (95%/5% water) and 25.8 g isopropanol. The mixture was refluxed for 20 minutes at 123-126° C. Monomers (222.4 g benzyl methacrylate, 74.2 g methacrylic acid, and 105.6 g hydroxypropylcarbamate acrylate, 70% HPCA in ethanol from BASF) were mixed and loaded in a 500 mL addition funnel. The initiator (14.87 g Wako V-501, 4,4′-azobis(4-cyanovaleric acid)) was mixed 2-pyrrollidone (370.6 g), and once a clear solution was obtained, it was loaded in a second 500 mL addition funnel. After an initial 10% add of the monomer to the reactor, the initiator and monomer feeds were feed concurrently over 4 hr while maintaining slight reflux, 125-128° C. After an additional hr of reaction at reflux, a second initiator mixture (2.23 g Wako V-501 and 55.6 g 2-pyrrollidone) was added over 1 hr followed an additional 40 min at reflux to finish off the reaction. The solution was further heated 130-132° C. with a Dean-Stark trap attached to remove IPA and other volatiles. The residual monomer by HPLC was 0.2% MAA, 0.9% BzMA and 0.2% HPCA. The final acrylic solution had a solids content of 40.20%, acid number of 156.35 mg KOH/g solids, and molecular weight by GPC of Mn 7592 and PD 2.02.

### Ink Additive 2: 20HPCA/60BMA/20MAA

A 2 L round bottom reactor equipped with mechanical stirrer, water cooled condenser and Nitrogen purge was loaded with 128.8 g 2-pyrrollidone (95%/5% water) and 25.7 g isopropanol. The mixture was refluxed for 25 minutes at 116-118° C. Monomers (222.4 g butyl methacrylate, 74.1 g methacrylic acid, and 105.9 g hydroxypropylcarbamate acrylate, 70% HPCA in ethanol from BASF) were mixed and loaded in a 500 mL addition funnel. The initiator (14.83 g Wako V-501, 4,4′-azobis(4-cyanovaleric acid)) was mixed 2-pyrrollidone (370.6 g), and once a clear solution was obtained, it was loaded in a second 500 mL addition funnel. After an initial 10% add of the monomer to the reactor, the initiator and monomer feeds were feed concurrently over 4 hr while maintaining slight reflux, 116-120° C. After an additional hr of reaction at reflux, a second initiator mixture (2.23 g Wako V-501 and 55.6 g 2-pyrrollidone) was added over 1 hr followed an additional 1 hr at reflux to finish off the reaction. The solution was further heated 131° C. with a Dean-Stark trap attached to remove IPA and other volatiles. The residual monomer by HPLC was 0.1% MAA, 0.1% BMA and 0.2% HPCA. The final acrylic solution had a solids content of 40.28%, acid number of 162.83 mg KOH/g solids, and molecular weight by GPC of Mn 9570, Mw 18103 and PD 1.89.

### Ink Additive 3: 20HPCA/70BMA/10MAA

A 2 L round bottom reactor equipped with mechanical stirrer, water cooled condenser and Nitrogen purge was loaded with 128.7 g 2-pyrrollidone (95%/5% water) and 25.8 g isopropanol. The mixture was refluxed for 25 minutes at 110° C. Monomers (260.0 g butyl methacrylate, 37.1 g methacrylic acid, and 106.0 g hydroxypropylcarbamate acrylate, 70% HPCA in ethanol from BASF) were mixed and loaded in a 500 mL addition funnel. The initiator (14.83 g Wako V-501, 4,4′-azobis(4-cyanovaleric acid)) was mixed 2-pyrrollidone (370.6 g), and once a clear solution was obtained, it was loaded in a second 500 mL addition funnel. After an initial 10% add of the monomer to the reactor, the initiator and monomer feeds were feed concurrently over 4 hr while maintaining slight reflux, 110-125° C. After an additional hr of reaction at reflux, a second initiator mixture (2.22 g Wako V-501 and 55.6 g 2-pyrrollidone) was added over 1 hr followed an additional 1 hr at reflux to finish off the reaction. The solution was further heated 131° C. with a Dean-Stark trap attached to remove IPA and other volatiles. The final acrylic solution had a solids content of 38.41%, acid number of 97.76 mg KOH/g solids, and molecular weight by GPC of Mn 9378, Mw 29231 and PD 3.12.

The properties of Ink Additives 1-3 are listed in Table 1 below.

TABLE 1

| Ink | Solid | | | | |
|---|---|---|---|---|---|
| Additive | Contents | | | | |
| No. | (%) | GPC Mn | GPC MW | GPC PD | Acid Num. |
| 1 | 40.20 | 7592 | 15320 | 2.02 | 156.35 |
| 2 | 40.28 | 9570 | 18103 | 1.89 | 162.83 |
| 3 | 38.41 | 9378 | 29231 | 3.12 | 97.76 |

Ink Additives 1-3 were neutralized with aqueous KOH to 90% basic on titrated values and dispersed in water until the polymer solid content reached 17-20%.

### Ink Preparation

Inks 1-4 were prepared using ingredients listed in Table 2 below.

TABLE 2

| | | | | Ink 4 |
|---|---|---|---|---|
| Ingredients | Ink 1 | Ink 2 | Ink 3 | (Control) |
| Black Pigment Dispersion 1 | 5.0% | 5.0% | 5.0% | 5.0% |
| Vehicle: | | | | |
| Ethylene glycol | 10.0% | 10.0% | 10.0% | 10.0% |
| 2-pyrrolidone | 10.0% | 10.0% | 10.0% | 10.0% |
| 1,2-hexanediol | 1.0% | 1.0% | 1.0% | 1.0% |
| Dipropylene Glycol Dimethyl | 2.5% | 2.5% | 2.5% | 2.5% |
| Ether | | | | |
| Surfynol 104E surfactant | 1.0% | 1.0% | 1.0% | 1.0% |
| Water | Balance to 100% | | | |
| Binder: | | | | |
| Additive 1 | 3.0% | — | — | — |
| Additive 2 | — | 3.0% | — | — |
| Additive 3 | — | — | 3.0% | — |

### Durability Testing

The inks were then drawndown on to HP multipurpose and Xerox 4200 papers using a #9 blade and were smudged with a small piece of Xerox 4200 paper after 10, 20, 30, 40, 60 and 80 seconds. The amount of ink transferred to the paper from the drawdowns was visually assessed and the results are shown Table 3 below.

TABLE 3

| | Example | Example | Example | Example |
|---|---|---|---|---|
| Substrate | 1 | 2 | 3 | 4 (Control) |
| HP Multipurpose | Very | Slight | Slight | Significant |
| paper | slight | | | |
| Xerox 4200 paper | Very | Slight | Very | Slight |
| | slight | | slight | |

The inventive inks containing the polymers showed improved smudge resistance compared to the control ink.

What is claimed is:

1. An aqueous inkjet ink comprising a colorant, an aqueous vehicle, and a polymeric ink additive as a binder, wherein said polymeric ink additive is a random or structured polymer and comprising at least three monomers A, B and C; wherein monomer A is a hydrophobic acrylate monomer, monomer B is a hydrophilic acrylic monomer, and monomer C is an acrylate monomer having a structure of Formula (I): 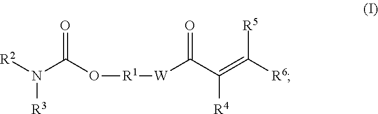
wherein W is O or NH;
R¹ is C₁-C₈ alkyl;
R², R³, R⁴, R⁵ and R⁶ are independently H or C₁-C₅ alkyl.

2. The ink of claim 1, wherein said monomer A is selected from the group consisting of benzyl methacrylate, butyl methacrylate, methyl methacrylate, ethyl methacrylate, propyl methacrylate, hexyl methacrylate, 2-ethylhexyl methacrylate, octyl methacrylate, lauryl ethacrylate, stearyl methacrylate, phenyl methacrylate, phenoxyethyl methacrylate, methyl acrylate, ethyl acrylate, propyl acrylate, butyl acrylate, hexyl acrylate, 2-ethylhexyl acrylate, octyl acrylate, lauryl acrylate, stearyl acrylate, benzyl acrylate, phenyl acrylate, phenoxyethyl acrylate, and styrene.

3. The ink of claim 2, wherein said monomer B is selected from the group consisting of methacrylic acid, acrylic acid, maleic acid, maleic acid monoester, itaconic acid, itaconic acid monoester, crotonic acid, crotonic acid monoester, N,N-dimethylaminoethyl methacrylate, N,N-diethylaminoethyl methacrylate, N,N-dimethylaminoethyl acrylate, N,N-diethylaminoethyl acrylate, t-butylaminoethyl methacrylate, t-butylaminoethyl acrylate, vinyl pyrridine, N-vinyl pyrridine, and 2-acrylamido-2-propane sulfonic acid.

4. The ink of claim 3, wherein W is O.

5. The ink of claim 4, wherein R¹ is CH₂CH₂(CH₃).

6. The ink of claim 5, wherein R² and R³ are H.

7. The ink of claim 5, wherein R² and R³ are C₁-C₅ alkyl.

8. The ink of claim 4, wherein R¹ is C₂H₄.

9. The ink of claim 8, wherein R² and R³ are H.

10. The ink of claim 8, wherein R² and R³ are C₁-C₅ alkyl.

11. The ink of claim 4, wherein R¹ is CH₂.

12. The ink of claim 11, wherein R² and R³ are H.

13. The ink of claim 11, wherein R² and R³ are C₁-C₅ alkyl.

14. The ink of claim 3, wherein W is NH.

15. The ink of claim 14, wherein R¹ is CH₂.

16. The ink of claim 15, wherein R² and R³ are H.

17. The ink of claim 15, wherein R² and R³ are C₁-C₅ alkyl.

18. The ink of claim 14, wherein R¹ is C₂H₄.

19. The ink of claim 18, wherein R² and R³ are H.

20. The ink of claim 18, wherein R² and R³ are C₁-C₅ alkyl.
